(19) United States
(12) Patent Application Publication
(10) Pub. No.: US 2012/0268821 A1
(43) Pub. Date: Oct. 25, 2012

(54) PRODUCTION METHOD FOR COMPOSITE TYPE DIFFRACTIVE OPTICAL ELEMENT, AND COMPOSITE TYPE DIFFRACTIVE OPTICAL ELEMENT

(75) Inventor: Shunichi Miyazawa, Utsunomiya-shi (JP)

(73) Assignee: CANON KABUSHIKI KAISHA, Tokyo (JP)

(21) Appl. No.: 13/442,276

(22) Filed: Apr. 9, 2012

(30) Foreign Application Priority Data
Apr. 21, 2011 (JP) 2011-094647

(51) Int. Cl. G02B 5/18; B29C 35/02; B29C 35/16; B29D 11/00

(52) U.S. Cl. 359/576; 264/1.1; 264/1.7

(57) ABSTRACT

A composite type diffractive optical element having a resin layer laminated on a transparent substrate is molded. Then, cooling of an unmolded surface of the transparent substrate is started using a cooling spray nozzle so as to provide a temperature gradient in one direction from an outer periphery toward a center, and a cooling range is expanded in the one direction to cool the transparent substrate. With this, mold releasing is performed in one direction from the outer periphery portion to an opposite outer periphery portion across the center of the diffraction gratings to release the resin layer from a diffraction grating mold.

### BACKGROUND OF THE INVENTION

1. Field of the Invention

The present invention relates to a production method for a composite type diffractive optical element used for optical equipment such as a camera or a video camera.

2. Description of the Related Art

Conventionally, in molding of a replica of a composite type diffractive optical element including a diffraction grating-shaped resin layer formed on a transparent substrate made of glass or the like, there is a problem in that, when the transparent substrate and resin layer are released from a mold after being integrated into one, the resin layer remains on the mold because of a large adhesion force between the resin layer and the mold. To deal with the problem, it is known that the residue of the resin layer on the mold can be prevented by performing a surface treatment in advance to increase the adhesion force between the transparent substrate and resin layer. In addition, it is known that the transparent substrate is warped by cooling the unmolded surface of the transparent substrate to reduce a mold releasing force, resulting in preventing the residue of the resin layer on the mold.

However, in the case of a mold including a diffraction grating on its surface such as a mold for molding a Fresnel lens or a diffraction optical element, the mold releasing force is larger than that of a mold including no diffraction grating. As a result, the resin layer tends to break and remain on the mold. Further, in the case where a diffraction grating is provided on the surface of the mold, mold releasing is particularly difficult because the resin layer is caught on the diffraction grating on the surface of the mold during the mold releasing to cause damages in the grating on the resin layer.

Japanese patent Application Laid-Open No. H01-152015 discloses a method of releasing a resin molded product from a mold having multiple gratings in a concentric fashion, which involves a combination of a step of cooling the unmolded surface of the transparent substrate from the outer periphery toward the center and a step of separating the product using a mold releasing pin. The cooling of the transparent substrate from the outer periphery toward the center causes a temperature difference in a thickness direction of the resin layer. With this, a shrinkage difference is generated at the interface between the resin layer and the transparent substrate, resulting in generating a bending moment in a direction to peel the molded surface (grating surface) of the resin layer off from the mold.

However, in the conventional example described in Japanese patent Application Laid-Open No. H01-152015, in the case where the transparent substrate is cooled from the outer periphery toward the center, the center portion cannot be released from the mold only by cooling. This is because the amount of deformation of the center portion of the transparent substrate by cooling is small, and in addition, a compressive force is applied in a mold direction by a bending deformation generated from the center of the transparent substrate as a fulcrum. Therefore, it is necessary to release the resin layer from the mold by lifting the unreleased portion of the center portion using mold releasing pins. In the case where the resin layer is released from the diffraction grating mold having multiple diffraction gratings in a concentric fashion, the mold releasing can be performed without damaging the gratings in the outer periphery portion because a shrinkage effect is added by the cooling step. However, the diffraction grating located at the center portion has a small shrinkage effect provided by cooling, and hence when the mold releasing is performed by lifting the resin using the mold releasing pins with force, the diffraction grating in the resin layer is caught on the diffraction grating in the diffraction grating mold to cause damages, which being a problem to be solved.

### SUMMARY OF THE INVENTION

To solve the above-mentioned problem, according to the present invention, there is provided a production method for a composite type diffractive optical element including: dropping a curable resin to a space between a diffraction grating mold having multiple diffraction gratings in a concentric fashion and a transparent substrate to fill the space by interposing; curing the curable resin filled in the space to mold a composite type diffractive optical element including a resin layer laminated on the transparent substrate; and releasing the composite type diffractive optical element from the diffraction grating mold, in which the mold releasing is performed in one direction from an outer periphery portion of the transparent substrate to an opposite outer periphery portion across a center of the diffraction gratings by starting cooling of an unmolded surface of the transparent substrate so as to provide a temperature gradient in one direction from the outer periphery toward the center and further cooling the transparent substrate by expanding a cooling range.

According to the present invention, when the mold releasing is performed in one direction by the cooling of the unmolded surface of the transparent substrate so as to create a temperature gradient, a bending moment provided by the shrinkage effect of the transparent substrate can be utilized effectively in the diffraction grating of the center portion in the same manner as in the outer diffraction grating. As a result, optical performance can be improved because the diffraction grating of the center portion can be released from the mold without damaging the diffraction grating located at the center portion.

Further features of the present invention will become apparent from the following description of exemplary embodiments with reference to the attached drawings.

### BRIEF DESCRIPTION OF THE DRAWINGS

FIGS. 1A, 1B, 1C, 1D, 1E, and 1F are cross-sectional views illustrating a production method for a composite type diffractive optical element according to the present invention.

FIGS. 2A, 2B, 2C, 2D, 2E, and 2F are cross-sectional views illustrating another production method for the composite type diffractive optical element according to the present invention.

FIGS. 3A, 3B, and 3C are schematic views illustrating cooling steps according to the present invention.

FIG. 4 is a cross-sectional view illustrating an example of the composite type diffractive optical element according to the present invention.

### DESCRIPTION OF THE EMBODIMENTS

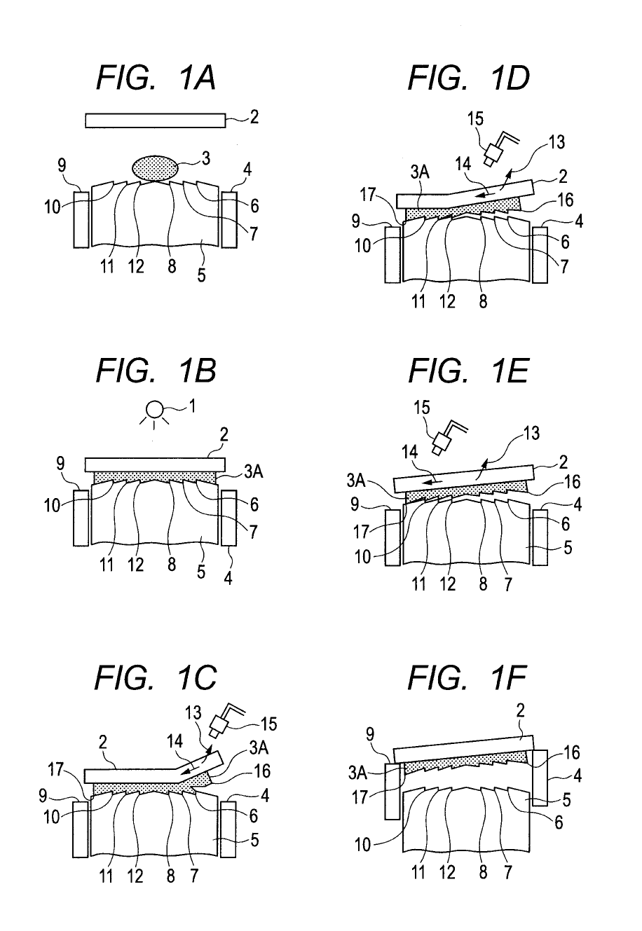

A production method for a composite type diffractive optical element according to an embodiment of the present invention is described with reference to FIGS. 1A to 1F. As illustrated in FIG. 1A, a photocurable resin 3 is dropped to a space between a diffraction grating mold having multiple diffraction gratings in a concentric fashion and a transparent substrate 2 and interposed therebetween to fill the space. At this time, in order to prevent mixing of air bubbles in the photocurable resin 3, it is necessary to adjust the rate of filling in consideration of the viscosity of the photocurable resin 3 and the wettability of each of the transparent substrate 2 and the diffraction grating mold 5. Further, it is necessary that the outer periphery portion of the transparent substrate 2 be put on the tops of mold releasing pins 4 and 9 arranged at given intervals in a circumferential direction to press the unmolded surface of the transparent substrate 2 while an inclination and absolute thickness of the resin layer are adjusted using the mold releasing pins 4 and 9.

After that, as illustrated in FIG. 1B, the transparent substrate 2 is irradiated with ultraviolet light 1 from the unmolded surface side to cure the photocurable resin 3 filled in the space, thereby molding a resin layer 3A. As a result, a composite type diffractive optical element including the resin layer 3A laminated on the transparent substrate 2 is molded.

Each of the diffraction gratings provided on the diffraction grating mold 5 has a height of 3.4 μm to 15 μm, and the transparent substrate 2 has an outer diameter of φ 32.5 mm to 100.5 mm. As a light source of the ultraviolet light 1, a high-pressure mercury lamp having an oscillation wavelength peak at 365 nm is used. The photocurable resin 3 is irradiated at an irradiation level of 5 J to 30 J at 0.1 mW/cm² to 100 mW/cm². When the irradiation level is less than 5 J, the shape of the resin layer 3A cured by the light is unstable to cause dispersion, and is changed with time. Therefore, it is necessary to irradiate the resin layer until a stable region. If the irradiation level is 30 J or more, the productivity is deteriorated because of long tact time.

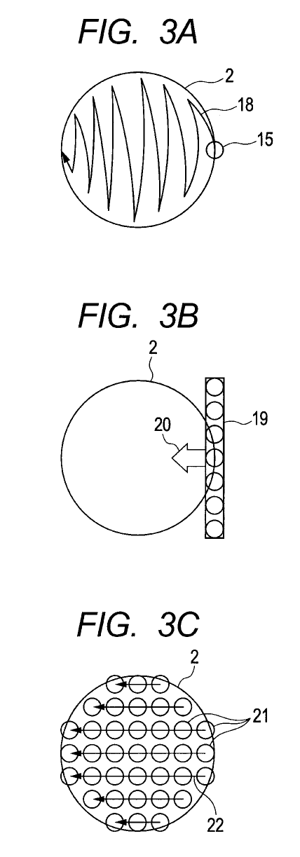

Next, as illustrated in FIG. 1C, the right half in the figure from the center of the transparent substrate is cooled. In the cooling, the right half of the unmolded surface of the transparent substrate 2 is cooled to −10 to −100° C. using a cooling spray nozzle 15. At this time, the cooling spray nozzle 15 is moved windingly as indicated in a moving direction 18 of FIG. 3A. With this, it is possible to release the resin layer 3A in one direction from the cooling side as illustrated in FIG. 1C. The temperature of the outer periphery portion of the uncooled side of the left half of the transparent substrate is adjusted to +24 to −5° C. to provide a temperature gradient in the transparent substrate 2, resulting in generating a warping deformation 13 and a shrinkage 14 from the outer periphery portion near the cooled portion of the transparent substrate 2. With this, the transparent substrate 2 is deformed to start releasing of the resin layer 3A laminated on the transparent substrate 2 from the initial mold releasing position 16 at the outer periphery of the resin layer.

There are provided temperature gradients between the right half and the left half, as the center of the transparent substrate 2 being a reference, and hence the mold releasing can be performed by expanding the cooling range in one direction from the cooled side toward the uncooled side. When the mold releasing is started from a part of the outer periphery, the mold releasing range can be expanded in one direction by cooling. However, if the cooling is performed at the same position for a long period of time without starting the mold releasing, the mold releasing may be started at the outer periphery because heat conduction in the transparent substrate 2 may lower the temperature of the uncooled side to start the mold releasing from the uncooled side. Similarly, in the case where the unmolded surface is cooled uniformly, the mold releasing is started at the outer periphery to damage the diffraction gratings in the resin layer 3A because an unpeeled part remains finally at the center portion. That is, it is important to give the temperature gradient so that the mold releasing is performed in one direction.

However, the cooling method is not limited thereto, and as illustrated in FIG. 3B, cooling may be performed by moving multiple cooling spray nozzles 19 arranged in series in a straight line toward the white arrow 20. As illustrated in FIG. 3C, the multiple cooling spray nozzles 21 located on the opposite side of the transparent substrate 2 may be sprayed in the order indicated by the arrows 22.

Next, as illustrated in FIG. 1D, the cooling spray nozzle 15 is moved from the outer periphery side of the transparent substrate 2 toward the center to expand the cooling range, thereby increasing the warping deformation 13 and shrinkage 14 in the transparent substrate 2. With this, the diffraction grating 6 located at the outer periphery portion of the initial mold releasing side and the diffraction grating 7 located at the middle portion of the initial mold releasing side are released from the mold in sequence in one direction, and the mold releasing is performed across the diffraction grating 8 located at the center portion of the initial mold releasing side toward the diffraction grating 12 located at the center portion of the opposite final mold releasing side.

Next, as illustrated in FIG. 1E, the cooling spray nozzle 15 is further moved so that the final mold releasing position always becomes the final mold releasing position 17 located at the outermost periphery, and the mold releasing is performed in one direction in an order of from the diffraction grating 11 located at the middle portion of the final mold releasing side to the diffraction grating 10 located at the outer periphery portion of the final mold releasing side. It should be noted that the cooling spray nozzle 15 may be fixed at the position illustrated in FIG. 1C to perform the mold releasing by heat conduction in the transparent substrate 2.

After that, as illustrated in FIG. 1F, the mold releasing pin 4 located on the initial mold releasing side and the mold releasing pin 9 located on the final mold releasing side are lifted to separate the resin layer 3A from the diffraction grating mold 5 while keeping the deformation of the transparent substrate 2 so as not to impair the one-direction mold releasing. With this, damages of gratings in the resin layer 3A, caused by returning the warping deformation 13 to the diffraction grating mold 5 side to cause a contact with the diffraction grating mold 5, are prevented. Further, it is important to release an integrated product including the transparent substrate 2 and resin layer 3A from the mold by lifting the mold releasing pin 4 located on the initial mold releasing side more (higher) than the mold releasing pin 9 located on the final mold releasing side. This is because mold releasing may be performed in an inverse direction in the case where the mold releasing pin 4 located on the initial mold releasing side is lifted less (lower) than the mold releasing pin 9 located on the final mold releasing side.

As described above, according to this embodiment, the mold releasing can be performed in one direction from the initial mold releasing position 16 to the final mold releasing position 17 in the opposite outer periphery portion across the diffraction grating 8 located at the center portion of the initial mold releasing side. With this, the diffraction grating 8 located at the center portion can be released from the mold in the same manner as the diffraction grating 6 located at the outer periphery portion without damaging the diffraction gratings in the resin layer 3A by the shrinkage of the transparent substrate 2.

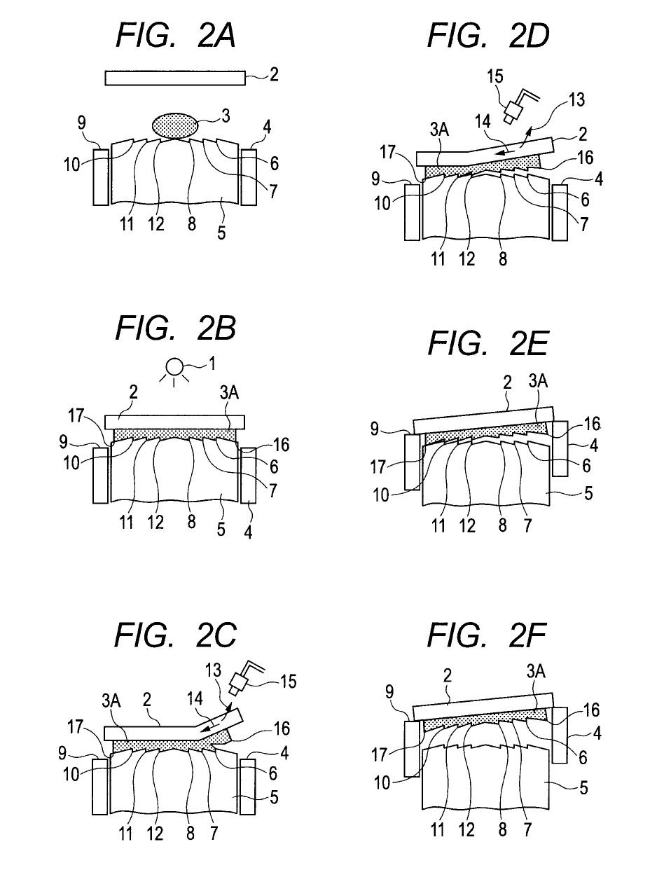

FIGS. 2A to 2F are explanatory drawings showing steps of the production method for a diffractive optical element according to another embodiment of the present invention.

In this embodiment, descriptions on the steps illustrated in FIGS. 2A, 2B, and 2C, which are the same as those in FIGS. 1A, 1B, and 1C, are omitted, and different steps are described.

As illustrated in FIG. 2D, at the time when the diffraction grating 8 located at the center portion of the initial mold releasing side is released from the mold, the cooling using the cooling spray nozzle 15 is stopped. This is performed to prevent adhesion of the diffraction gratings in the resin layer 3A tightly to the diffraction gratings 12, 11 and 10 located on the final mold releasing side to cause difficulty in mold releasing due to the shrinkage of the transparent substrate 2 toward the direction of the final mold releasing position 17 by cooling the transparent substrate 2 across the center toward the direction of the final mold releasing position 17.

Then, as illustrated in FIG. 2E, the mold releasing is performed in the unreleased portion in one direction by lifting the mold releasing pin 4 located on the initial mold releasing side more (higher) than the mold releasing pin 9 located on the final mold releasing side.

Further, as illustrated in FIG. 2F, the mold releasing is performed in one direction toward the final mold releasing position 17 to separate the resin layer 3A from the diffraction grating mold 5 using the mold releasing pin 4 located on the initial mold releasing side and the mold releasing pin 9 located on the final mold releasing side.

It should be noted that, in the steps later than the step illustrated in FIG. 2C, if the diffraction grating mold 5 is expanded by heating to distend the diffraction grating outward, an allowable width interfered with by the diffraction grating on the mold releasing is increased.

According to this embodiment, when the resin layer 3A is released from the mold in one direction by cooling from the outer periphery portion of the diffraction grating mold 5 to the diffraction grating 8 located at the center portion of the initial mold releasing side, the diffraction grating 8 located at the center portion of the initial mold releasing side can be released from the mold by utilizing the shrinkage of the transparent substrate 2 in the same manner as the diffraction grating 6 located at the outer periphery portion of the initial mold releasing side. Further, the mold releasing from the diffraction grating 12 located at the center portion of the final mold releasing side to the final mold releasing position 17 is performed by lifting the mold releasing pin 4 located on the initial mold releasing side after the stop of the cooling because an action to adhere to the transparent substrate tightly to the diffraction grating is generated by the shrinkage of the transparent substrate 2 due to the cooling. With this, the mold releasing from the diffraction grating 12 located at the center portion on the final mold releasing side to the final mold releasing position 17 can be performed at high yields while preventing tight adhesion caused by the cooling.

It should be noted that not only the photocurable resin illustrated in the above-mentioned embodiment but also known curable resins may be used.

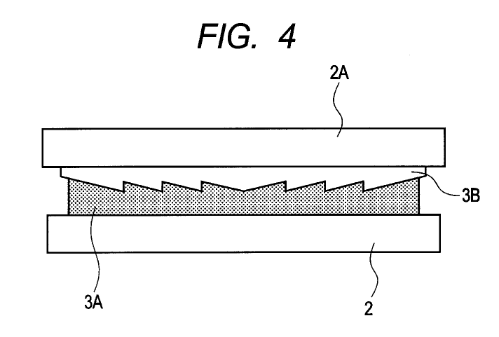

Meanwhile, a curable resin different from the resin layer 3A is arranged on the diffraction grating surface of the resin layer 3A of the composite type diffractive optical element including the transparent substrate 2 and resin layer 3A illustrated in FIGS. 1B and 2B, and a second transparent substrate 2A is further arranged thereon. With this, a space between the resin layer 3A and the second transparent substrate 2A is filled with the arranged curable resin. Further, the curable resin is cured to form a resin layer 3B. As a result, a multilayered diffractive optical element as illustrated in FIG. 4 can be formed.

### Example 1

An ultraviolet photocurable resin was dropped to fill a space between a diffraction grating mold having multiple diffraction gratings created by cutting and a transparent substrate with the resin by interposing. After that, a transparent substrate was irradiated with ultraviolet light using a high-pressure mercury lamp from the unmolded surface side to light-cure the ultraviolet photocurable resin. The diffraction grating had a height of 10 μm, and the transparent substrate had an outer diameter of φ 37 mm. The ultraviolet photocurable resin was irradiated with ultraviolet light at an irradiation level of 30 J (30 mW/cm²×1,000 sec).

The right half of the unmolded surface of the transparent substrate was cooled to −23° C. using a cooling spray nozzle, and the temperature of the outer periphery portion of the uncooled side located at the left half using the center of the transparent substrate as a reference was adjusted to +20° C. so that the transparent substrate had a temperature gradient. With this, the mold releasing was started by the deformation of the transparent substrate in one direction from the initial mold releasing position in the outer periphery portion of the resin layer laminated on the transparent substrate.

The cooling spray nozzle was moved toward the direction of the center of the transparent substrate to expand the cooling range. With this, warping deformation and shrinkage of the transparent substrate increased to perform the mold releasing across a diffraction grating located at the center portion of the initial mold releasing side toward a diffraction grating located on the opposite side, i.e., the final mold releasing side. Further, the cooling spray nozzle was moved to the unreleased direction, and the mold releasing was performed in one direction.

When a mold releasing pin on the initial mold releasing side was lifted more (higher) than that on the final mold releasing side, an integrated product including the transparent substrate and ultraviolet photocurable resin was released from the mold in one direction.

As mentioned above, according to this example, the mold releasing can be performed in one direction from the initial mold releasing position to the final mold releasing position in the opposite outer periphery portion across the diffraction grating located at the center portion of the initial mold releasing side. With this, the diffraction grating located at the center portion can be released from the mold in the same manner as the diffraction grating located at the outer periphery portion without damaging the diffraction gratings in the resin layer by a bending moment generated by the shrinkage of the transparent substrate.

### Example 2

The ultraviolet photocurable resin was dropped, interposed between the transparent substrate and diffraction grating mold, and irradiated with ultraviolet light to cure the resin.

The right half of the unmolded surface of the transparent substrate was cooled to −55° C. using the cooling spray nozzle. At this time, the temperature of the outer periphery portion of the uncooled side of the left half from the center of the transparent substrate was +2° C., and there was a temperature gradient in the transparent substrate. With this, the mold releasing was started by deformation of the transparent substrate of the cooled side in one direction from the initial mold releasing position in the outer periphery portion of the resin layer laminated on the transparent substrate.

At the time when the diffraction grating located at the center portion of the initial mold releasing side was released from the mold, the cooling using the cooling spray nozzle was stopped, and the mold release pin on the initial mold releasing side was lifted more than that on the final mold releasing side to deform the transparent substrate and to perform the mold releasing in one direction.

Further, the mold release pin on the initial mold releasing side and the mold release pin on the final mold releasing side were lifted in a vertical direction to perform the mold releasing in one direction toward the final mold releasing position until the final mold releasing.

As described above, according to this example, when the resin layer is released from the mold in one direction by the cooling from the outer periphery portion of the diffraction grating mold to the diffraction grating located at the center portion of the initial mold releasing side, the diffraction grating located at the center portion can be released from the mold by the shrinkage of the transparent substrate in the same manner as the diffraction grating located at the outer periphery portion of the initial mold releasing side. Further, the mold releasing from the diffraction grating located at the center portion of the final mold releasing side to the final mold releasing position is performed by lifting the mold release pin on the initial mold releasing side after the stop of the cooling because an action to adhere to the transparent substrate tightly to the diffraction grating is generated by the shrinkage of the transparent substrate due to cooling.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2011-094647, filed Apr. 21, 2011, which is hereby incorporated by reference herein in its entirety.

What is claimed is:

1. A production method for a composite type diffractive optical element including a resin layer, the resin layer being formed on a transparent substrate and having multiple diffraction gratings in a concentric fashion, the production method comprising:
filling a space between a diffraction grating mold and a transparent substrate with a curable resin by interposing;
curing the curable resin filled in the space to mold a composite type diffractive optical element including a resin layer laminated on the transparent substrate;
starting cooling of an unmolded surface of the transparent substrate so as to provide a temperature gradient in one direction from an outer periphery toward a center thereof;
cooling an entire of the transparent substrate by expanding a cooling range in the one direction; and
releasing the molded composite type diffractive optical element from the diffraction grating mold along the one direction from the outer periphery portion of the transparent substrate to an opposite outer periphery portion across the center of the diffraction gratings.

2. The production method according to claim 1, further comprising heating the diffraction grating mold when the element is released from the mold.

3. A composite type diffractive optical element produced by the production method according to claim 1.

4. A production method for a multilayered diffractive optical element, comprising:
filling a space between a diffraction grating mold and a first transparent substrate with a first curable resin by interposing;
curing the curable resin filled in the space to mold a composite type diffractive optical element including a first resin layer laminated on the first transparent substrate;
starting cooling of an unmolded surface of the first transparent substrate so as to provide a temperature gradient in one direction from an outer periphery toward a center thereof;
cooling an entire of the first transparent substrate by expanding a cooling range in the one direction;
releasing the first resin layer of the molded composite type diffractive optical element from the diffraction grating mold along the one direction from the outer periphery portion of the first transparent substrate to an opposite outer periphery portion across the center of the diffraction gratings;
arranging a second curable resin, which is different from the resin layer, on the diffraction grating surface of the composite type diffractive optical element;
arranging a second transparent substrate on the second resin layer to fill a space between the first resin layer and the second transparent substrate with the second curable resin; and
curing the second resin layer.

5. A multilayered diffractive optical element produced by the production method according to claim 4.

6. A production method for a composite type diffractive optical element including a resin layer, the resin layer being formed on a transparent substrate and having multiple diffraction gratings in a concentric fashion, the production method comprising:
filling a space between a diffraction grating mold and a transparent substrate with a curable resin by interposing;
curing the curable resin filled in the space to mold a composite type diffractive optical element including a resin layer laminated on the transparent substrate;
starting cooling of an unmolded surface of the transparent substrate so as to provide a temperature gradient in one direction from an outer periphery toward a center thereof;
expanding a cooling range in the one direction and stopping cooling at a position beyond a center portion of the diffraction gratings; and
releasing the molded composite type diffractive optical element from the diffraction grating mold along the one direction from the outer periphery portion of the transparent substrate to an opposite outer periphery portion across the center of the diffraction gratings.

7. The production method according to claim 6, further comprising heating the diffraction grating mold when the element is released from the mold.

8. A composite type diffractive optical element produced by the production method according to claim 6.

9. A production method for a multilayered diffractive optical element, the production method comprising:
filling a space between a diffraction grating mold and a transparent substrate with a curable resin by interposing;
curing the curable resin filled in the space to mold a composite type diffractive optical element including a resin layer laminated on the transparent substrate;
starting cooling of an unmolded surface of the transparent substrate so as to provide a temperature gradient in one direction from an outer periphery toward a center thereof;
expanding a cooling range in the one direction and stopping cooling at a position beyond a center portion of the diffraction gratings;
releasing the molded composite type diffractive optical element from the diffraction grating mold along the one direction from the outer periphery portion of the transparent substrate to an opposite outer periphery portion across the center of the diffraction gratings;
arranging a second curable resin, which is different from the resin layer, on the diffraction grating surface of the composite type diffractive optical element;
arranging a second transparent substrate on the second resin layer to fill a space between the first resin layer and the second transparent substrate with the second curable resin; and
curing the second resin layer.

10. A multilayered diffractive optical element produced by the production method according to claim 9.
